(19) United States
(12) Patent Application Publication
(10) Pub. No.: US 2023/0165239 A1
(43) Pub. Date: Jun. 1, 2023

(54) Collapsible call horn for hunters which generates sampled animal calls

(71) Applicant: Marcel Gagne, Lac Etchemin (CA)

(72) Inventor: Marcel Gagne, Lac Etchemin (CA)

(21) Appl. No.: 18/070,005

(22) Filed: Nov. 28, 2022

(30) Foreign Application Priority Data
Nov. 29, 2021 (GB) 2117233.3

(51) Int. Cl. A01M 31/00

(52) U.S. Cl. CPC A01M 31/004

(57) ABSTRACT

A collapsible call horn for hunters which generates sampled animal calls is comprised of a cone shaped horn made out of a resiliently deformable material, having ridges and creases on the cone perimeter so as to create a bellows configuration to allow for the cone to collapse onto itself so as to reduce the cone's relative size.

### CROSS-REFERENCE TO RELATED APPLICATIONS

The present application claims priority to application number GB2117233.3, filed on Nov. 29, 2021, the disclosure of which is hereby incorporated in its entirety at least by reference.

### BACKGROUND OF THE INVENTION

### 1. Field of the Invention

The present invention relates generally to hunting paraphernalia but more particularly to a collapsible call horn for hunters which generates sampled animal calls.

### 2. Description of Related Art

In hunting, one strategy to attract game is to imitate the sound of the animal you are tracking. More often than not, hunters will use a horn, such s an old style non electronic megaphone to amplify and amplify their tone so as to best imitate the call of the animal being hunted. The problem is that not all hunters are good at imitating animal sounds. There are some call horns that incorporate a compact speaker and a sound chip which has pre-recorded animal sounds. Another problem with current call horns is that they can be quite bulky and not practical to carry around if one wants to be as stealth as possible and carry as little bulky gear as possible. There is room for improvement in that field.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide for a collapsible call horn for hunters which generates sampled animal calls.

In order to do so, the present invention has a cone shaped horn made out of a resiliently deformable material, having ridges and creases on the cone perimeter so as to create a bellows configuration to allow for the cone to collapse onto itself so as to reduce the cone's relative size.

The collapsible call horn has a cover plate to cover an electronic module located inside the horn; the cover plate has controls so that an intended user can select the type of calls, the intensity, and duration of the call.

In a preferred embodiment, the resiliently deformable material is an RTV silicone

In another preferred embodiment, the sounds are activated by way of an app from a smart phone and a wireless communication protocol between the phone and the horn.

The collapsible call horn has a method of use consisting in the steps of:

1) the intended user extending the horn by pulling on it;

2) turning the power on;

3) accessing an app on his phone which has a convivial interface to select the type of calls and the parameters;

4) pointing the horn in a desired direction to send out the call.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 Isometric view according to an embodiment of the invention.

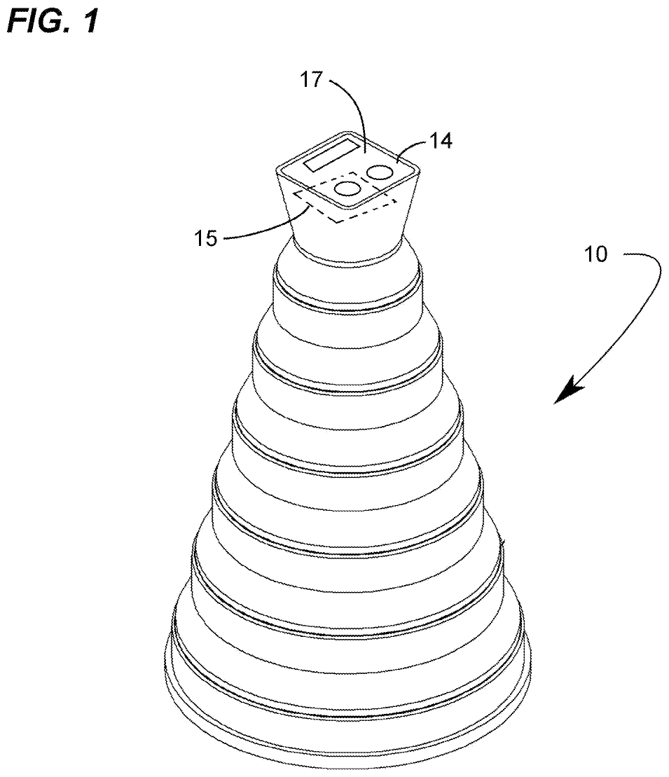

FIGS. 2A-B Side elevation and cutaway side view of the invention.

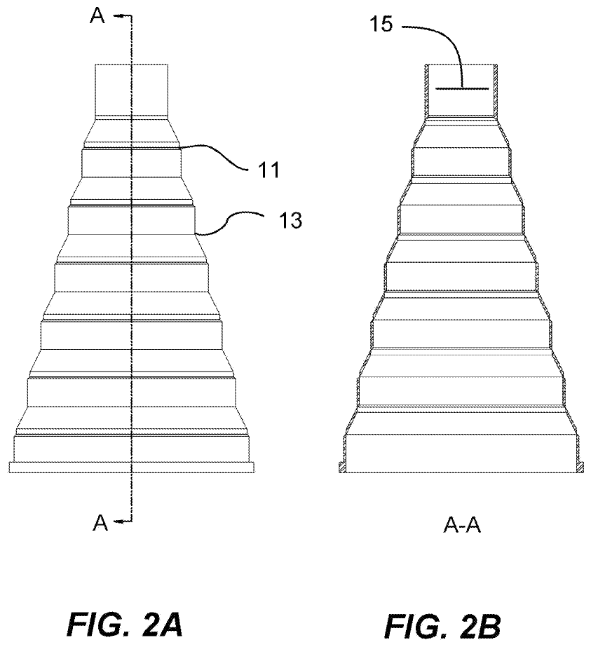

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

Referring now to any of the accompanying FIGURES, there is provided a cone shaped horn (10) made out of a resiliently deformable material such as, for example RTV silicone, and having ridges (11) and creases (13) on its perimeter so as to create a bellows configuration to allow for the cone (10) to collapse—accordeon style—onto itself and thus be more compact.

The horn (10) has a cover plate (14) in place of the mouthpiece to hide an electronic module (15) located inside the horn (10). The cover plate (14) is where controls (17) are located so that an intended user can select the type of calls, the intensity (volume), and duration of the call, among other possible options.

The controls (not shown) can be directly on the horn (10) itself, or from a phone app which connects to the horn (10) by way of Bluetooth™ or any such wireless communications protocol. The horn's battery are located under the (not shown) can be recharged via USB.

The horn (10) has a method of use consisting in the steps of:

1) the intended user extending the horn by pulling on it;

2) turning the power on;

3) accessing an app on his phone which has a convivial interface to select the type of calls and the parameters;

4) pointing the horn (10) in a desired direction to send out the call.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A collapsible call horn for hunters which generates sampled animal calls comprising a cone shaped horn made out of a resiliently deformable material, having ridges and creases on the cone perimeter so as to create a bellows configuration to allow for the cone to collapse onto itself so as to reduce the cone's relative size.

2. The collapsible call horn of claim 1 wherein: the horn has a cover plate to cover an electronic module located inside the horn; the cover plate has controls so that an intended user can select the type of calls, the intensity, and duration of the call.

3. The collapsible call horn of claim 1 wherein: resiliently deformable material is an RTV silicone

4. The collapsible call horn of claim 1 wherein: the sounds are activated by way of an app from a smart phone and a wireless communication protocol between the phone and the horn.

5. The collapsible call horn of claim 1 having a method of use consisting in the steps of:
1. the intended user extending the horn by pulling on it;
2. turning the power on;
3. accessing an app on his phone which has a convivial interface to select the type of calls and the parameters;
4. pointing the horn in a desired direction to send out the call.
